(19) United States
(12) Patent Application Publication
(10) Pub. No.: US 2006/0283477 A1
(43) Pub. Date: Dec. 21, 2006

(54) Interdental cleaning article with functional messages

(76) Inventors: Bryan Oronsky, Los Altos, CA (US); Neil Oronsky, Los Altos, CA (US); Denise Oakes-Lottridge, Fort Myers, FL (US); Andrew Oakes-Lottridge, Fort Myers, FL (US)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 11/155,403

(22) Filed: Jun. 16, 2005

(51) Int. Cl. A61C 15/00

(52) U.S. Cl. 132/321

(57) ABSTRACT

The invention features interdental hygiene articles, as well as dispensers for use in conjunction with such and methods of use to promote good oral hygiene practices. In particular the invention is directed to interdental hygiene articles such as flosses, tapes, ribbons, and/or the like, wherein the interdental hygiene articles includes one or more graphics on one ore more sides of the article. The graphic demarcates a recommended length of the article to be used in a single use procedure, and can be provided so as to promote use of the article over different regions of the length used.

### FIELD OF THE INVENTION

This invention is related to dental hygiene articles, more specifically interdental cleaning articles, as well as dispensers for dispensing such and methods of use. Specifically, this invention is related to interdental cleaning articles such as dental flosses, tapes, and filaments that promote better, more effective oral hygiene habits.

### BACKGROUND OF THE INVENTION

The most common way of minimizing the number of bacteria in the mouth is to develop good oral hygiene habits that include both brushing and flossing the teeth regularly. However, developing good oral hygiene habits is challenging. Useful practices such as flossing can be both time consuming and tedious. Making this practice even more challenging is the difficulty in learning the proper techniques for use, the appropriate length of floss to dispense, and how to use the floss in such a way so as not to spread bacteria from one area to another. Because of these impediments and others most people do not find flossing an enjoyable activity.

Dental tapes and flosses are primarily made up of multitudinous cylindrical fibers of varying diameters and fiber structures. These interdental cleaning articles are used to cleanse the interdental and subgingival regions of the mouth. However, their improper use can be deleterious. For instance, re-using the same section of floss can result in moving food, plaque, germs, bacteria, and the like carried by the floss from one region to another rather than removing them entirely from the mouth. Although this is undesirable, it is often difficult to determine the sections of the floss that have already been used, which makes it difficult to avoid re-using sections of the floss.

Conventional methods for encouraging good oral hygiene habits, such as regular flossing with floss or dental tape, have focused on laborious teaching methods, detailed descriptions of the maladies associated with not flossing, and adding various different types of flavoring to the floss. Although these methods are geared to make the practice of flossing a regular routine for the user, they do not make the process more enjoyable or easier, and thus they have had minimal over all lasting effect in increasing the practice of flossing.

There is, therefore, a need for a dental hygiene article that is fun to use and more effective in both motivating use and promoting better, more effective, flossing techniques. Accordingly, the apparatuses and methods consistent with the present invention meet those needs.

### SUMMARY OF THE INVENTION

The invention features interdental hygiene articles, as well as dispensers for use in conjunction with such, and methods of use to promote good oral hygiene practices. In particular, the invention is directed to interdental hygiene articles such as flosses, tapes, ribbons, and/or the like, wherein the interdental hygiene articles includes one or more messages on one ore more sides of the article. The message demarcates a recommended length of the article to be used in a single use procedure, and can be provided so as to promote use of the article over different regions of the length used.

In one aspect, the invention provides an interdental hygiene article, such as a floss, tape, ribbon, or the like, wherein the interdental hygiene article includes a message at least on one side that demarcates a recommended length of the article to be used in a single use. In accordance with this aspect, the interdental hygiene article is demarcated into segments that are marked by the message in such a way so as to allow the user to distinguish one segment from another, thereby indicating how much of the interdental hygiene article is to be used for a single procedure. In one embodiment, the interdental hygiene article is a cleaning aid such as a gum stimulator, an interdental pick, and the like, wherein one or both ends include a message.

In another aspect, the invention provides a dispenser for a interdental hygiene article of the invention. In one embodiment, at least a portion of the dispenser is transparent so the message on the interdental hygiene article can be visualized prior to dispensing and/or the interdental hygiene article can be viewed prior to its running out.

In another aspect the invention provides a method of using a interdental hygiene article of the invention which generally involves visualizing and dispensing a demarcated length of the interdental hygiene article, which length is determined by the message present on the article; severing the appropriate demarcated length of the interdental hygiene article; and flossing between the subjects teeth, that is the interdental and subgingival regions, with the article.

In one embodiment, is provided an interdental hygiene article that includes a first and a second elongated and opposite surface and a plurality of message-demarcated segments on at least one of said first and second surfaces, said segments defining a length of the interdental hygiene article suitable for a single use. The interdental hygiene article may be in the form of a dental tape, a floss, a ribbon, or the like, that is fabricated of fibers, monofilaments, or multifilaments of nylon, satin, gortex, Teflon, or the like that is either waxed or unwaxed.

In one embodiment, the interdental hygiene article includes message-dermarcated segments each independently having a marking indicating all or a portion of a day of the week, a day of the month; a number of days until a given holiday; a number of shopping days until a given holiday; a mathematical formulas; a rule of grammar; a name of a country; a name of a state or province within a country; a name of a capitol within a state, province, or country; a name of a public figure; a reported fact; a fact to be reported; a fortune; a name of a fictional character; a name of a professional or amateur athlete; a name of a professional or amateur team; a song lyric; a name of a company or business; a stock symbol of a publicly traded company; a symbol; an image; or an advertisement.

Additionally, the message-demarcated segments may contain a trivia question, a trivia answer, a brain teaser, a joke, a puzzle clue, and an updates on character interactions from a television show. In this embodiment, the message-demarcated segments may be provided on each of the first and second elongated surfaces of the interdental hygiene article, wherein the message of the first and second sides of the interdental hygiene article may be complementary interactive messages, such as: an interrogatory and answer; a true false question and answer; a fill in the blank question and answer; a set up and punchline of a joke. The message of the first side may or may not be positioned in direct alignment with the message on the second and opposite side. However, the message should be positioned on the first and second sides so as to promote use of the interdental hygiene article over different portions of the length of the message-demarcated segment.

In another embodiment, the interdental hygiene article may include a message on at least one of its first and second sides that is not visible or not fully visible until after use. Accordingly, the interdental hygiene article may also include a demarcation by one or more visible symbols demarcating the length of the segment. The message may be rendered non-visible by a biologically inert coating that at least partially covers the message, wherein the coating is rubbed off during use to reveal the message. Such a coating may be any coating that is well known in the art as being biologically inert and capable of being rubbed off through normal use of the floss. For instance: dried, pasted, powdered, or baked on bicarbonate (such as sodium bicarbonate), edible dyes, wax, artificial sweeteners, toothpaste, and the like. Other coatings that may be included are biologically active coatings, such as antibiotics, procoagulants, analgesics, anti-inflammatory agents, antiseptics, whiteners, immunoglobulins specific for Streptococci and Enterococci, lidocaine, amylase inhibitors, glucosidase-inhibitors, fluoride, chlorhexidine, green tea or extracts, anise, tea tree oil and extracts, epinephrine, oil of cloves, non-steroidal anti-inflammatory agents, anti-tussives, narcotic analgesics, stimulants, analgesic antipyretics, iron sales, vitamin C, and lysozyme.

In one embodiment the interdental hygiene article further includes a pH-sensitive dye, wherein markings on the article are formed with the pH-sensitive dye and made readable by the pH of a healthy mouth environment. The message demarcated useable length may further comprises a different color from an adjoining length.

In another aspect of the invention, a dispenser for dispensing the interdental hygiene article is provided. In one embodiment, at least a portion of the dispenser includes a transparent material, and/or may be made of a clear material. Additionally, a magnifying glass may be included as part of or in addition to the dispenser. The magnifying glass may be in the configuration of a ring (e.g., made out of plastic) that can be fitted to a finger that the interdental hygiene article wraps around and thereby facilitate both the use and reading of the floss.

In another aspect, the invention provides a method of using the interdental hygiene article, which includes dispensing a demarcated length of the interdental hygiene article of and flossing between the teeth, wherein said length is demarcated by message on at least one side of the hygiene article.

### BRIEF DESCRIPTION OF THE DRAWINGS

FIG. 1 is a perspective view of an interdental hygiene article according to an illustrative but non-limiting embodiment of the present invention.

FIG. 2 is a perspective view of an interdental hygiene article dispenser according to an illustrative but non-limiting embodiment of the present invention.

### DEFINITIONS

Before the present invention is further described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a,” “and,” and “the” include plural referents unless the context clearly dictates otherwise. Thus, for example, reference to “a text” includes a plurality of such texts and reference to “the segment” includes reference to one or more segments and equivalents thereof known to those skilled in the art, and so forth. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

By “an interdental hygiene article” is meant any elongated material having a surface suitable both for displaying a message and for cleaning between the interdental and subgingival regions of the mouth. In particular, the term “interdental hygiene article” indicates and may be used interchangeably with the terms a “dental floss”, a “ribbon”, a “tape”, and may indicate other such filament that promote better, more effective oral hygiene habits. The term “interdental hygiene article” may also be an elongate cleaning aid such as a gum stimulator, an interdental pick, and the like, wherein one or both ends include a message.

By “message” is meant a communication of an underlying idea that is by writing, symbol, or signal, or the like so long as it conveys a concept or image that is indicative of the length of segment to be used in a single procedure. In particular a “message” is a text or symbol.

### DETAILED DESCRIPTION OF THE INVENTION

In general, the invention provides interdental hygiene articles, as well as dispensers containing such articles and methods of use, which promote good dental hygiene. In general, the interdental hygiene article is demarcated into segments by messages in such a way to allow the user to distinguish one segment from another, thereby indicating how much of the interdental hygiene article is to be used for a single procedure. Optionally, and in addition, the messages of the demarcated segments are provided so as to encourage use over different portions of the demarcated segment, thereby encouraging the user to avoid re-use of the same segment during a cleaning procedure. INTERDENTAL HYGIENE ARTICLES OF THE INVENTION

The invention provides for an interdental hygiene article, such as a floss, tape, ribbon, or the like that includes one or more message-demarcated segments, e.g., text-demarcated segments, that define a usable length of the interdental hygiene article to be used in a single procedure. According to this aspect, each segment is marked by a message in such a way so as to distinguish one segment from another. The interdental hygiene article of the invention is best used in conjunction with the dispenser of this invention. However, the interdental hygiene article can be constructed in such a way so as to be adapted to any suitable dispensers, such as a dental floss or tape dispenser, that are well known in the art.

The interdental hygiene article can be fabricated from materials commonly known and used in the dental industry such as standard floss fibers, monofilaments, multifilaments, dental tape, ribbons, and the like, and may be made out of nylon, satin, gortex, Teflon, etc. See for instance, the monofilament interproximal flosses and tapes described in: U.S. Pat. Nos. 5,760,117; 5,433,226; 5,479,952; 5,503,842; 5,755,243; 5,845,652; 5,884,639; 5,918,609; 5,962,572; 5,998,431; 6,003,525; 6,083,208; 6,148,830; 6,161,555; 6,027,592; and 6,604,534, and the multifilament flosses described in U.S. Pat. Nos. 4,911,927; 5,057,310; 5,098,711; 5,165,913; and 5,711,935, the disclosures of which are hereby incorporated herein their entirety by reference.

In one embodiment, and as described in more detail below, the message is printed on a least one side of the interdental hygiene article during or after manufacture, using standard printing means well known in the art, with the message being of a length commensurate with a length suitable for a single use in teeth cleaning.

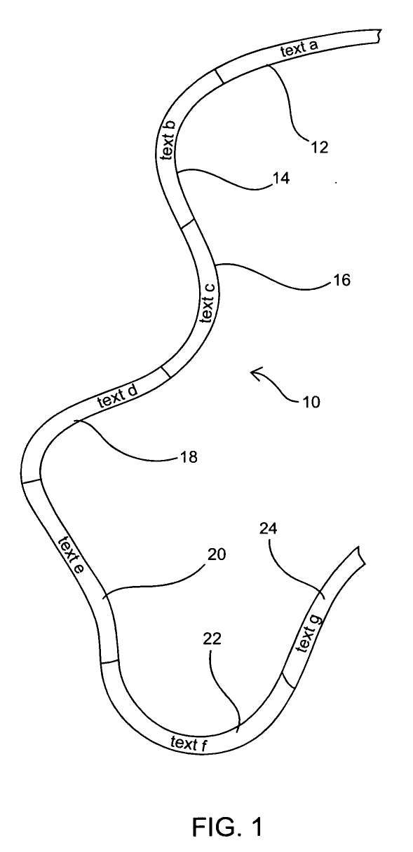

FIG. 1 is a perspective view of an exemplary interdental hygiene article 10 according to an illustrative but non-limiting embodiment of the present invention. A portion of the interdental hygiene article 10 can be seen. The interdental hygiene article 10 is a thread-like member, preferably having first and second sides opposite one another, and being of a width suitable for conveying a message to the user, preferably without a reading aid, such as a magnifying glass.

The interdental hygiene article 10, of FIG. 1, includes a plurality of message-demarcated segments, exemplified in this embodiment by “text a”, “text b”, and the like, see, e.g., 12-20. Each segment normally has a uniform length that is optimized to provide a recommended amount of the interdental hygiene article 10 that is suitable for use in a single procedure. Adjoining segments 12-24 in this exemplary embodiment have different messages thereon to provide a visual demarcation of the proper length of the interdental hygiene article to be used. For example, segment 12 may be demarcated by “text a,” and segment 14 may be demarcated “text b.” Such different messages along the length of the article can also indicate that the user has used preceding segments (e.g., a demarcated segment can indicate the day of the week or day of the month that should correspond to the day of use if the user has flossed once daily).

In general, and as exemplified in FIG. 1, a user dispenses the length of the interdental hygiene article demarcated by “text a” (i.e., segment 12), clips that segment, and then performs a flossing procedure with the length of the interdental hygiene article demarcated by “text a” (i.e., segment 12). Accordingly, on the next use, the user would then dispense the length of the interdental hygiene article demarcated by “text b” (i.e., segment 14) clip that segment, and then perform a flossing procedure with the length of the interdental hygiene article demarcated by “text b” (i.e., segment 14). Thus, a user may use a dispenser to dispense a desired length of the interdental hygiene article to be used for a single procedure.

In another embodiment, the interdental hygiene article is a cleaning aid such as a gum stimulator, an interdental pick, and the like (e.g., toothpick) wherein one or both ends include a message. As will be further described below, the message may readily apparent or it may be covered over with biocompatible covering substance, such as a baked on bicarbonate, hibiscus, etc., wherein the message is revealed with use of the article.

Messages

The message used to demarcate a suitable, single-use length of the interdental hygiene article may comprise any graphic design that conveys a meaning so that the user recognizes that the message length corresponds to a particular length of interdental hygiene article, thereby encouraging the user to sever the article for a single use at a length that corresponds to the message's length “Graphic design” as used herein is meant to include any combination of letters, characters, numbers, symbols, signs, images, pictures, and the like which conveys a message to a user. In some embodiments, the message is provided in Braille. It is to be noted that the invention is not limited to a particular message to demarcate one segment from another, so long as the message included on the interdental hygiene article is for the purpose of demarcating an appropriate length of the article to be used in a single flossing procedure, that is a single use. The message may be provided on one or both sides of the interdental hygiene article, and may be the same or different from that on the opposing side.

The message demarcating the different segments to be used per procedure may be, for example, one or more words, a formula, a code, a word jumble, a name, or trademark, and may comprise, for example, a series of words to from a phrase, slogan, or sentence.

The interdental hygiene article is generally composed of a collection of demarcated segments, each of which includes a message that can be independently selected to provide a different combination of messages of different meanings, or can be selected so as to provide a “theme” over multiple segments (e.g., over a length of a roll of the article contained within a single dispenser, which dispenser can be optionally marked according to the theme of messages provided on the article contained therein).

For example, the demarcation can include a day of the week; a day of the month; a month of the year; a number of days until a given holiday or event (with or without the holiday or event provided with the number); a number of shopping days until a given holiday or event (with or without the holiday or event indicated with the number); a mathematical or chemical or biological formula; a rule of grammar; a name of a country; a name of a state or province within a country; a name of a capitol within a state; province or country; a name of a public figure (e.g., a known political figure, athlete, entertainer (e.g., musician, actor, comedian, and the like), inventor, scientist, physician, or other celebrity); a reported fact or fact to be reported; instructions (e.g., instructions on how to use the dental hygiene article); a fortune; a name of a fictional character (e.g., a cartoon, comic, movie, television, or book character, especially a children's fictional character); a name of a professional or amateur athlete; a name of a professional or amateur athletic team; a song lyric; a name of a publicly traded or private company; a stock symbol of a publicly traded company; an advertisements or other promotional message; and/or the like.

In other embodiments, the demarcation may include a message that conveys a trivia question, a trivia answer, a brain-teaser, a joke (e.g., a set-up, which can be followed by a punchline), and a portion of a story (e.g., as in an update on character interactions from a television show, e.g., a television series (e.g., a soap opera)).

In one embodiment, a message on a first side of the interdental hygiene article may be in the form of an interrogatory, a true false question, a fill in the blank question, a set up for a joke, and/or a set up for a character assessment. In accordance with this embodiment, a message on a second opposite side opposite the first side may correspond to a response to the message on the first side (e.g., an answer to an interrogatory, an answer to a true false question, an answer to a fill in the blank question, a punch-line for a joke, and/or an answer to a set up for a character assessment), so as to provide a complementary interactive message. The message on one side of the interdental hygiene article may be positioned in direct alignment with the text on the opposite side, or it may be positioned so it is not in direct alignment with the text on the opposite side, in which case proper use of the article will be promoted by having to use the entire length of the article to be able to read the text on the opposite side.

In accordance with the above-described embodiment, the text on one side of the interdental hygiene article may be unreadable over all or at least a portion of the message until used. In this embodiment, the unreadable message may become readable upon proper use. For instance, the unreadable message may be covered by a biologically inert or biologically active material that renders all or a portion of the message unreadable until, through proper use of the article, the material is rubbed off or otherwise removed by use (e.g., due to wetting of the coating, a change in pH of the coating, and the like). Such materials may include, but are not limited to, dried, pasted, powdered, or baked on bicarbonate (e.g., sodium bicarbonate), artificial sweeteners, toothpaste, or the like. Any such agent that is biologically compatible and capable of coating the article may be used. The interdental hygiene article may be impregnated by a suitable material and/or coated on one or more sides with the material by means well known in the art, such as baking.

According to one embodiment, the message may be configured to comprise a game entry, e.g., a lottery, whereby the message is unreadable until used, and upon use the coating is rubbed off to reveal whether a prize has been won. Such prizes can be points, coupons, monetary awards, or other various articles of value.

In another embodiment, the interdental hygiene article may comprise “fortune floss,” wherein the message comprises a “fortune” or “horoscope.” In connection herewith, the floss may be configured and/or packaged to be placed with in a “fortune cookie” or other cookie or sweet.

In another embodiment, all or a portion of the message may be rendered unreadable through use of pH-sensitive dye. All or a portion of the message may be printed or otherwise disposed on the article with the pH-sensitive dye such that contact of the article through proper use to the pH of the mouth environment causes a change in the pH of the dye, rendering the message readable. In this or any other related embodiment, the portion of the article on which the partially or wholly unreadable message is disposed can be demarcated by one or more symbols demarcating the suggested useable length (e.g., flanking the partially or wholly unreadable message).

A message may be applied to the interdental hygiene article using standard methods well known in the art, such as printing. For example, and not to be limited hereby, a message or design can be lightly etched or scored onto the surface of the interdental hygiene article and then a biocompatible ink (e.g., an edible ink) could be applied on top of that. Or the message could be printed onto a piece of rice paper or cellulose and then placed on one surface of the floss and preserved under a wax coating.

Accordingly, the printed message may be printed onto orally soluble edible films through standard printing techniques (e.g., such as by use of a template stamp) in combination with the use of an edible ink. One, two, three, or more inks may be used. For instance, two types of inks may be employed. The first type may be an ink made from a solution containing the same film forming ingredient as in the orally soluble edible film being printed upon, to which dye or pigment is added. The second type may be commonly available vegetable dies. The printing can be done in one or more colors. The ink can be flavorless, or can add one or flavors or salivary stimulants that will help produce saliva to dissolve the film, or can add tartness or sourness.

The interdental hygiene article may also contain coloring agents or colorants. The coloring agents are used in amounts effective to produce the desired color. Some coloring agents include pigments such as titanium dioxide, may be incorporated in amounts of up to about 5 wt % or more. Colorants can also include natural food colors and dyes suitable for food. They may be such that they are capable of changing under biological temperatures, pH, and other physiologic conditions that can be induced by finger touch or contact with saliva. Saliva is relatively acidic and can be used to induce an acidic environment which can cause a chromic change in foods containing the chromic material. For example, the chromic material can be sensitized to respond to physiologic temperatures (98° F.), which can be useful for indicating the areas of interdental hygiene article that have been used. The methyl or ethyl ester of 10,12-tricosadiynoic acid or 10,12-pentacosadiynoic acid is made by standard esterification in methanol or ethanol respectively. The ester compound can be applied to foodstuffs, crystallized and then polymerized at or below room temperature. The dark chromic material is extremely sensitive to thermal contact and changes color immediately at 70° F. for the tricosadiynoate ester and at 80° F. or above for the pentacosadiynoate estersmetic applications. These colorants are known as FD&C dyes and lakes. The materials acceptable for the foregoing spectrum of use could be water-soluble, and include FD&C Blue No. 2, which is the disodium salt of 5,5-indigotindisulfonic acid. Similarly, the dye known as Green No. 3 comprises a triphenylmethane dye and is the monosodium salt of 4-[4-N-ethyl-p-sulfobenzylamino) diphenyl-methylene]-[1-N-ethyl-N-p-sulfonium benzyl)-2,5-cyclo-hexadienim-ine]. A full recitation of all FD&C and D&C dyes is available in industry literature.

Further, multiple colors can be used within the same film. Not by way of limitation, this can be accomplished two ways: First, by using multiple feed streams of different colors when casting or extruding the films; and second, by have a multiple-layer film with each layer of a different color. In the latter case, the film can be co-cast or co-extruded, or can be bonded together with a water soluble edible binder. While in most films it would not be desirable for the film to leave color in the mouth, a further aspect of the interdental hygiene article is to use the type of dye, such as vegetable dyes, that leave the tongue and/or teeth colored after flossing. Soluble ink that rubs off with use can be used to see which spaces in between the teeth were missed (by the absence of coloring.) during a flossing procedure, so long as the dye is capable of being washed away by rinsing the mouth.

In one embodiment, different discrete colored dots comprised within burstable blisters may be used on an interdental hygiene article, where by the action of putting it in the mouth and moving it back and forth causes the dots to bleed and create swirls and other patterns of color. In one embodiment, the blister dots are arranged on the interdental hygiene article in a configuration whereby an object of use is to try and connect the dots. In another embodiment, the blister dots further comprise biologically active agents that are released with the dye upon use of the floss. In another embodiment, the blister dots may be configured for Braille.

Additionally, the interdental hygiene article may be waxed or non-waxed, flavored or unflavored, and/or colored or uncolored, and/or modified in any other suitable way with the proviso that such coatings or treatments do not interfere with the ability to read the message or make the message readable upon use according to the embodiments described herein. For instance, after printing a thin wax coating may be applied to the interdental hygiene article so as to prevent the printing from rubbing off. Additionally, the interdental hygiene article may include a scent, such as a citrus scent, that when used is released, thus emitting a pleasant odor, e.g., oranges, bubble-gum, lavender. The interdental hygiene article may include an inert or active agent coating, and/or may contain a mixture of inert and active agents, including agents that are reconstituted by the saliva present in the subjects' mouth, again with the proviso that such coatings or agents do not interfere with the ability to read the message or make the message readable upon use according to the embodiments described herein.

Exemplary biologically active agents that may be added to the interdental hygiene article include, but are not necessarily limited to, antibiotics, procoagulants, analgesics, anti-inflammatory agents, antiseptics, whiteners, and the like. Other active agents may include immunoglobulins, such as antibodies or monoclonal antibodies specific for S. epidermidis, P. aeruginosa, S. aureus, S. sanguis, S. mutans, Bacteroides gingivalis, Streptococci and Enterococci. Other exemplary agents include, but are not limited to, lidocaine, amylase inhibitors (e.g., hibiscus, hibiscus-acid, roselle tea or extracts thereof, tannin, starch blockers and the like), glucosidase-inhibitors, fluoride, chlorhexidine, green tea or extracts, anise, tea tree oil and extracts, epinephrine, oil of cloves, non-steroidal anti-inflammatory agents (e.g., aspirin, diflunisal, fenoprofen calcium, naproxen, acetaminophen, ibuprofen, ketoprofen, tolmetin sodium, indomethacin, and the like), anti-tussives (e.g., benzonatate, caramiphen edisylate, menthol, dextromethorphan hydrobromide, chlophedianol hydrochloride, and the like), narcotic analgesics (e.g., morphine, heroin, hydromorphone, metopon, oxymorphone, levorphanol, codeine, hydrocodone, xycodone, nalorphine, naloxone, naltrexone and the like), stimulants (caffeine, nicotine, and the like), analgesic antipyretics (e.g,. such as salycilates, phenylbutazone, indomethacin, phenacetin and the like), iron salts (e.g., ferric sulfate), vitamin C (ascorbic acid), lysozyme, or other agent beneficial to oral health and/or that promote good oral hygiene (e.g., through reduction of bleeding, inflammation, pain, and the like).

It is a further object of this invention to provide for a method of using a interdental hygiene article of the invention, such as a floss, tape, ribbon, or the like, on a subjects teeth, which includes: visualizing and dispensing a demarcated length of the interdental hygiene article, that is determined by the text present on the article; severing the appropriate demarcated length of the interdental hygiene article; and flossing between the subjects teeth, that is the interdental and subgingival regions, with the article.

Exemplary Dispenser

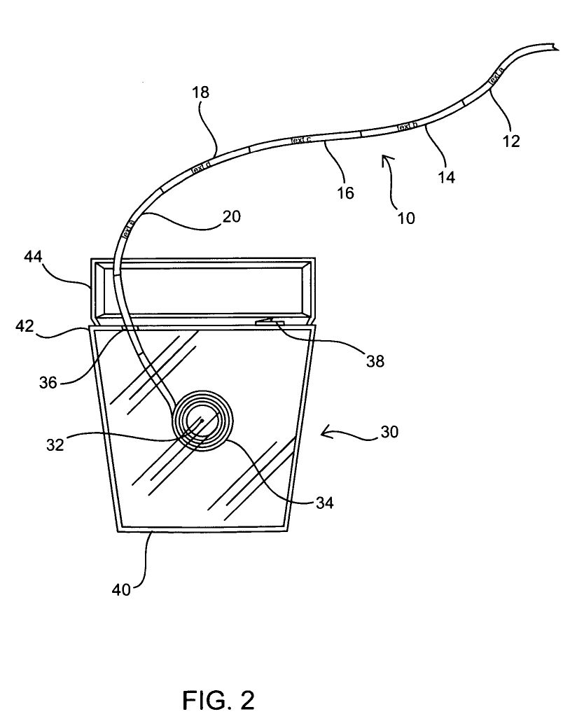

The invention also provides the interdental hygiene article of the invention in a dispenser. FIG. 2 shows a perspective view of an exemplary interdental hygiene article dispenser 30 according to an illustrative but non-limiting embodiment of the present invention. An interdental hygiene article of the invention 10 is contained within the dispenser 30. The dispenser 30 includes a housing 40 that includes a cap portion 36. The housing 40 includes an axle 32 that supports a spool 34 that is configured to rotate about the axle 32. The interdental hygiene article 10 is wound around the spool 34 and exits the top boundary member 42 through an aperture 38 upon being dispensed from the dispenser 30. The top boundary member 42 of the housing 40 includes a shearing member 38 for cutting the interdental hygiene article 10 at the appropriate length.

The dispenser shown in FIG. 2 can be partially or wholly constructed of a transparent material that allows a user to view at least a portion of the article prior to dispensing (e.g., to provide one or more windows on a portion of the dispenser that allows for previewing the message prior to dispensing). In FIG. 2, the dispenser is of a transparent material (e.g., a clear plastic) such that the axle 32 and spooling mechanism 34 upon which the interdental hygiene article 10 is wound is visible. In this embodiment, the transparent material allows a viewer to inspect the amount of the interdental hygiene article 10 on the spool 34 and thereby determine if the interdental hygiene article 10 is running out and the dispenser 30 needs to be replaced. The axle 32 or the spool 34 or both can also be constructed out of a clear material to better allow for viewing the amount of interdental hygiene article 10 remains.

It is to be understood that although the embodiment set forth in FIG. 1 depicts a housing 40 that is constructed out of a clear material, this is in no way limitingas to what materials the housing 40 can be constructed out of. For instance, in one embodiment the housing is constructed out of a semi-clear material. In another embodiment the housing is constructed out of an opaque material that includes a one or more windows for viewing at least a potion of the article (e.g., to preview the message on the article) and/or for viewing the axle and spool. In a further embodiment, the dispenser is constructed out of an opaque material thereby preventing a user from seeing through the dispenser. The materials described herein can be colorless or can be colored plastic, or the like (e.g., PET or HDPE).

In another embodiment, the dispenser may be configured to dispense litmus paper in conjunction with the interdental hygiene article, wherein the two come out of the dispenser together and are either already detached are capable of being detached by separating them across perforated line. In this instance, a message can be printed on the piece of litmus paper, interdental hygiene article, or both, and the article can be rubbed on the litmus paper after its use to analyze the pH of the saliva. Accordingly, the litmus paper can be configured so that several different pH ranges can be detected at once, each with a separate pH range message and/or written in a slightly different color and/or highlighted separately, according to the color of the litmus paper. For example, and in no means limiting, the range of 7-7.2 could be in blue and if the litmus turned a certain color it would highlight this particular range over the other ranges.

A method of using an interdental hygiene article is also provided. The method comprises: dispensing a demarcated length of the interdental hygiene article described herein above; and flossing between the teeth of a subject, wherein the length to be dispensed is demarcated by a message on at least one side of the hygiene article.

What is claimed is:

1. An interdental hygiene article comprising:
a first and a second elongated and opposite surfaces; and
a plurality of message-demarcated segments on at least one of said first and second surfaces, said segments defining a length of the interdental hygiene article suitable for a single use.

2. The interdental hygiene article of claim 1, wherein said interdental hygiene article is formed of a member selected from the group consisting of a dental tape, a floss, and a ribbon.

3. The interdental hygiene article of claim 1, wherein said interdental hygiene article comprises a member selected from the group consisting of a fiber, a monofilament, and a multifilament.

4. The interdental hygiene article of claim 1, wherein said message-demarcated segments each independently comprise a marking selected from the group consisting of: a marking indicating all or a portion of a day of the week; a day of the month; a number of days until a given holiday, a number of shopping days until a given holiday, a mathematical formulas; a rule of grammar; a name of a country; a name of a state or province within a country; a name of a capitol within a state, province, or country; a name of a public figure; a reported fact; a fact to be reported; a name of an fictional character; a names of a professional or amateur athlete; a name of a professional or amateur team; a song lyric; a name of a company or business; a stock symbol of a publicly traded company; a symbol; an image; and an advertisement.

5. The interdental hygiene article of claim 1, wherein said message-demarcated segments each independently comprise a marking selected from the group consisting of a trivia question, a trivia answer, a brain teaser, a joke, a puzzle clue, and an updates on character interactions from a television show.

6. The interdental hygiene article of claim 1, wherein said message-demarcated segments are provided on each of said first and second elongated surfaces of the interdental hygiene article.

7. The interdental hygiene article of claim 6, wherein the message of the first and second sides of the interdental hygiene article are complementary interactive messages.

8. The interdental hygiene article of claim 7, wherein the complementary interactive messages on said first and second sides is selected from the group consisting of: an interrogatory and answer; a true false question and answer; a fill in the blank question and answer; a set up and punchline of a joke.

9. The interdental hygiene article of claim 8, wherein the message of the first side of the interdental hygiene article is positioned in direct alignment with the message on the second and opposite side.

10. The interdental hygiene article of claim 9, wherein the message on the first side of the interdental hygiene article is not positioned in direct alignment with the message of the second and opposite side.

11. The interdental hygiene article of claim 10, wherein the message is positioned on the first and second sides so as to promote use of the interdental hygiene article over different portions of a length of the message-demarcated segment.

12. The interdental hygiene article of claim 11, wherein the message on at least one of said first and second sides of the interdental hygiene article is not visible or not fully visible until after use.

13. The interdental hygiene article of claim 12, further comprising a demarcation by one or more visible symbols demarcating the length of the segment.

14. The interdental hygiene article of claim 12, wherein the interdental hygiene article comprises a coating which at least partially covers the message, wherein the coating is rubbed off during use to reveal the message.

15. The interdental hygiene article of claim 14, wherein the coating is a biologically inert coating.

16. The interdental hygiene article of claim 14, wherein the coating is a biologically active coating.

17. The interdental hygiene article of claim 16, wherein the biologically active coating comprises a material selected from the group consisting of antibiotics, procoagulants, analgesics, anti-inflammatory agents, antiseptics, whiteners, immunoglobulins specific for Streptococci and Enterococci, lidocaine, amylase inhibitors, glucosidase-inhibitors, fluoride, chlorhexidine, green tea or extracts, anise, tea tree oil and extracts, epinephrine, oil of cloves, non-steroidal anti-inflammatory agents, anti-tussives, narcotic analgesics, stimulants, analgesic antipyretics, iron salts, vitamin C, and lysozyme.

18. The interdental hygiene article of claim 12, wherein the interdental hygiene article further comprises a pH-sensitive dye.

19. The interdental hygiene article of claim 18, wherein markings on the article are formed with the pH-sensitive dye.

20. The interdental hygiene article of claim 19, wherein the message is made readable by the pH of a healthy mouth environment.

21. The interdental hygiene article of claim 1, wherein the message demarcated useable length further comprises a different color from an adjoining length.

22. A dispenser containing the interdental hygiene article of claim 1.

23. The dispenser of claim 22, wherein at least a portion of the dispenser comprises a transparent material.

24. The dispenser of claim 23, wherein the dispenser is made of a clear material.

25. The dispenser of claim 22, wherein the interdental hygiene article is waxed.

26. A method of using an interdental hygiene article, comprising the steps of:
dispensing a demarcated length of the interdental hygiene article of claim 1; and
flossing between said teeth, wherein said length is demarcated by message on at least one side of the hygiene article.
